(19) United States
(12) Patent Application Publication
(10) Pub. No.: US 2005/0018669 A1
(43) Pub. Date: Jan. 27, 2005

(54) Infiniband subnet management queue pair emulation for multiple logical ports on a single physical port

(75) Inventors: Richard Louis Arndt, Austin, TX (US); Bruce Leroy Beukema, Hayfield, MN (US); David F. Craddock, New Paltz, NY (US); Thomas Anthony Gregg, Highland, NY (US); Donald William Schmidt, Stone Ridge, NY (US); Bruce Marshall Walk, Rochester, MN (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/626,988

(22) Filed: Jul. 25, 2003

(51) Int. Cl. H04L 12/56

(52) U.S. Cl. 370/389; 370/412

(57) ABSTRACT

A Host Channel Adapter supporting a plurality of Logical Partitions is provided. A Subnet Manager, having an associated aliased Queue Pair, may run in a Logical Partition. A single physical subnet management Queue Pair and its associated firmware are provided for each physical port in the Host Channel Adapter. If a packet is to be routed to a Subnet Manager residing in a Logical Partition, the packet is enqueued on the physical port's send queue for transmission to the aliased Queue Pair for the Subnet Manager. The Host Channel Adapter hardware loops the packet back to the aliased Queue Pair in the appropriate Logical Partition. The aliased Queue Pair is also capable of transmitting packets that are looped back to a Hypervisor Subnet Management Agent.

### BACKGROUND OF THE INVENTION

1. Technical Field

The present invention is directed to an improved data processing system. More specifically, the present invention is directed to an apparatus and method for subnet manager queue pair emulation for multiple logical ports on a single physical port.

2. Description of Related Art

InfiniBand (IB) provides a hardware message passing mechanism which can be used for Input/Output devices (I/O) and Interprocess Communications (IPC) between general computing nodes. Consumers access IB message passing hardware by posting send/receive messages to send/receive work queues on an IB Channel Adapter (CA). The send/receive work queues (WQ) are assigned to a consumer as a Queue Pair (QP). Consumers retrieve the results of these messages from a Completion Queue (CQ) through IB send and receive work completions (WC).

The source CA takes care of segmenting outbound messages and sending them to the destination. The destination CA takes care of reassembling inbound messages and placing them in the memory space designated by the destination's consumer. There are two CA types: Host CA and Target CA. The Host Channel Adapter (HCA) is used by general purpose computing nodes to access the IB fabric. Consumers use IB verbs to access Host CA functions. The software that interprets verbs and directly accesses the CA is known as the Channel Interface (CI).

Each Queue Pair is conventionally associated with a physical port in a CA. However, it is desirable for a Host CA to be associated with multiple logical partitions of a server. Therefore, an efficient mechanism is needed to associate a single physical port and queue pair with multiple logical partitions. Therefore, it would be advantageous to have such a method, apparatus, and program to direct packets to logical partitions within a Host CA.

### SUMMARY OF THE INVENTION

The present invention provides a Subnet Manager Queue Pair communication channel for each logical port on a logical Host Channel Adapter and for each logical switch. Rather than including separate physical resources for each of these low-utilization communications channels, a single physical Queue Pair zero and its associated firmware are provided for each physical port. Queue Pairs are communication channels for ports on a Host Channel Adapter. The Queue Pair zero is the communication channel for subnet management traffic. The mechanism of the present invention routes and processes this traffic on behalf of multiple logical ports.

A Subnet Management Agent, which responds to subnet management requests, may be provided for each logical port or switch. Also, a Subnet Manager, having an associated Queue Pair zero, may run in a Logical Partition. A Subnet Manager Queue Pair associated with a Logical Partition is referred to as an aliased Queue Pair. Using its associated aliased Queue Pair, the Subnet Manager may communicate with other nodes on the subnet as well as logical nodes within the same physical Host Channel Adapter.

All packets are received on a single Queue Pair for each physical port and are processed by hypervisor code referred to as the Hypervisor Subnet Management Agent. If a packet is to be routed to a Subnet Manager residing in a Logical Partition, the packet is enqueued on the physical port's send queue for transmission to the aliased Queue Pair for the Subnet Manager. The Host Channel Adapter hardware loops the packet back to the aliased Queue Pair in the appropriate Logical Partition. The aliased Queue Pair is capable of transmitting packets externally. The aliased Queue Pair is also capable of transmitting packets that are looped back to the Hypervisor Subnet Management Agent.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a distributed computer system is illustrated in accordance with a preferred embodiment of the present invention;

FIG. 2 is a functional block diagram of a host processor node in accordance with a preferred embodiment of the present invention;

FIG. 3A is a diagram of a host channel adapter in accordance with a preferred embodiment of the present invention;

FIG. 3B is a diagram of a switch in accordance with a preferred embodiment of the present invention;

FIG. 3C is a diagram of a router in accordance with a preferred embodiment of the present invention;

FIG. 4 is a diagram illustrating processing of work requests in accordance with a preferred embodiment of the present invention;

FIG. 5 is a diagram illustrating a portion of a distributed computer system in accordance with a preferred embodiment of the present invention in which a reliable connection service is used;

FIG. 6 is a diagram illustrating a portion of a distributed computer system in accordance with a preferred embodiment of the present invention in which reliable datagram service connections are used;

FIG. 7 is an illustration of a data packet in accordance with a preferred embodiment of the present invention;

FIG. 8 is a diagram illustrating a portion of a distributed computer system in accordance with a preferred embodiment of the present invention;

FIG. 9 is a diagram illustrating the network addressing used in a distributed networking system in accordance with the present invention;

FIG. 10 is a diagram illustrating a portion of a distributed computing system in accordance with a preferred embodiment of the present invention in which the structure of SAN fabric subnets is illustrated;

FIG. 11 is a diagram of a layered communication architecture used in a preferred embodiment of the present invention;

FIG. 12 depicts a Host Channel Adapter in a Logical Partitioning environment in accordance with a preferred embodiment of the present invention;

FIG. 13 illustrates an example of subnet management dataflow for traffic in a Logical Partitioning environment in accordance with a preferred embodiment of the present invention;

FIG. 14 is a flowchart illustrating the processing of a received subnet management packet in a Host Channel Adapter in accordance with a preferred embodiment of the present invention; and

FIG. 15 is a flowchart illustrating the process of sending a subnet management packet in a Host Channel Adapter in accordance with a preferred embodiment of the present invention.

### DETAILED DESCRIPTION OF THE PREFERRED EMBODIMENT

The present invention provides an apparatus and method for managing subnet management Queue Pairs for Logical Partitions in a Host Channel Adapter. The present invention may be implemented in hardware, software, or a combination of hardware and software. The present invention is preferably implemented in a distributed computing system, such as a system area network (SAN) having end nodes, switches, routers, and links interconnecting these components.

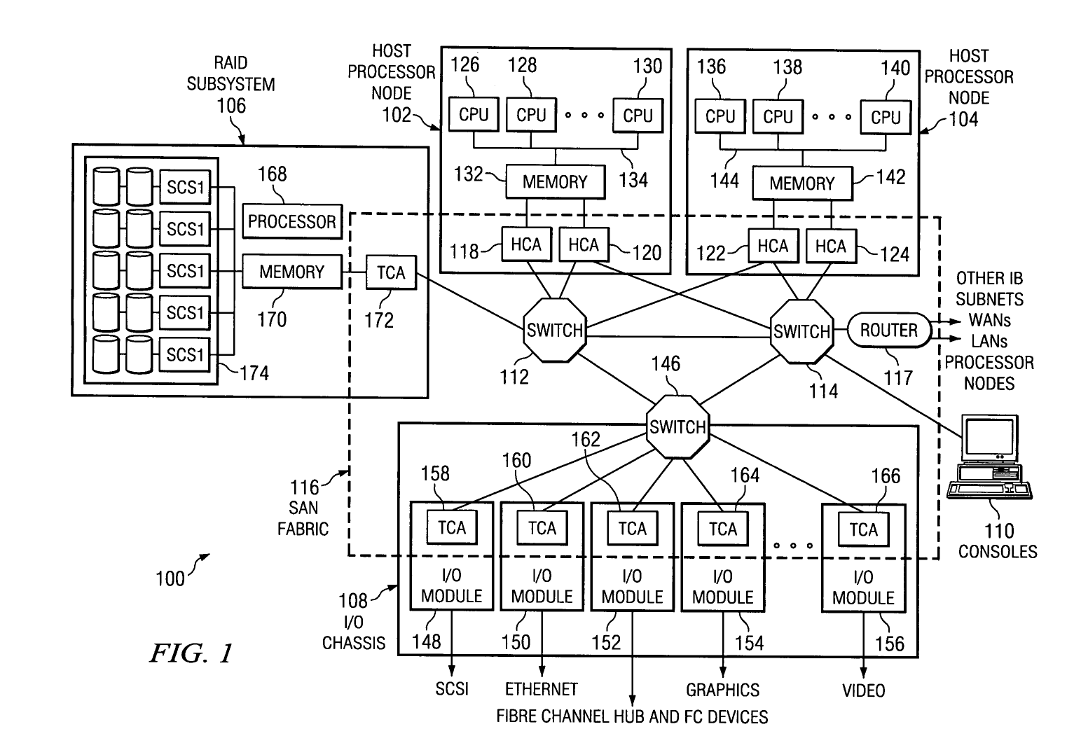

FIG. 1 is a diagram of a distributed computer system in accordance with a preferred embodiment of the present invention. The distributed computer system represented in FIG. 1 takes the form of a system area network (SAN) 100 and is provided merely for illustrative purposes, and the embodiments of the present invention described below can be implemented on computer systems of numerous other types and configurations. For example, computer systems implementing the present invention can range from a small server with one processor and a few input/output (I/O) adapters to massively parallel supercomputer systems with hundreds or thousands of processors and thousands of I/O adapters.

SAN 100 is a high-bandwidth, low-latency network interconnecting nodes within the distributed computer system. A node is any component attached to one or more links of a network and forming the origin and/or destination of messages within the network. In the depicted example, SAN 100 includes nodes in the form of host processor node 102, host processor node 104, redundant array independent disk (RAID) subsystem node 106, and I/O chassis node 108. The nodes illustrated in FIG. 1 are for illustrative purposes only, as SAN 100 can connect any number and any type of independent processor nodes, I/O adapter nodes, and I/O device nodes. Any one of the nodes can function as an end node, which is herein defined to be a device that originates or finally consumes messages or frames in SAN 100.

In one embodiment of the present invention, an error handling mechanism in distributed computer systems is present in which the error handling mechanism allows for reliable connection or reliable datagram communication between end nodes in distributed computing system, such as SAN 100.

A message, as used herein, is an application-defined unit of data exchange, which is a primitive unit of communication between cooperating processes. A packet is one unit of data encapsulated by networking protocol headers and/or trailers. The headers generally provide control and routing information for directing the frame through SAN 100. The trailer generally contains control and cyclic redundancy check (CRC) data for ensuring packets are not delivered with corrupted contents.

SAN 100 contains the communications and management infrastructure supporting both I/O and interprocessor communications (IPC) within a distributed computer system. The SAN 100 shown in FIG. 1 includes a switched communications fabric 116, which allows many devices to concurrently transfer data with high-bandwidth and low latency in a secure, remotely managed environment. End nodes can communicate over multiple ports and utilize multiple paths through the SAN fabric. The multiple ports and paths through the SAN shown in FIG. 1 can be employed for fault tolerance and increased bandwidth data transfers.

The SAN 100 in FIG. 1 includes switch 112, switch 114, switch 146, and router 117. A switch is a device that connects multiple links together and allows routing of packets from one link to another link within a subnet using a small header Destination Local Identifier (DLID) field. A router is a device that connects multiple subnets together and is capable of routing frames from one link in a first subnet to another link in a second subnet using a large header Destination Globally Unique Identifier (DGUID).

In one embodiment, a link is a full duplex channel between any two network fabric elements, such as end nodes, switches, or routers. Example suitable links include, but are not limited to, copper cables, optical cables, and printed circuit copper traces on backplanes and printed circuit boards.

For reliable service types, end nodes, such as host processor end nodes and I/O adapter end nodes, generate request packets and return acknowledgment packets. Switches and routers pass packets along, from the source to the destination. Except for the variant CRC trailer field, which is updated at each stage in the network, switches pass the packets along unmodified. Routers update the variant CRC trailer field and modify other fields in the header as the packet is routed.

In SAN 100 as illustrated in FIG. 1, host processor node 102, host processor node 104, and I/O chassis 108 include at least one channel adapter (CA) to interface to SAN 100. In one embodiment, each channel adapter is an endpoint that implements the channel adapter interface in sufficient detail to source or sink packets transmitted on SAN fabric 116. Host processor node 102 contains channel adapters in the form of host channel adapter 118 and host channel adapter 120. Host processor node 104 contains host channel adapter 122 and host channel adapter 124. Host processor node 102 also includes central processing units 126-130 and a memory 132 interconnected by bus system 134. Host processor node 104 similarly includes central processing units 136-140 and a memory 142 interconnected by a bus system 144.

Host channel adapters 118 and 120 provide a connection to switch 112 while host channel adapters 122 and 124 provide a connection to switches 112 and 114.

In one embodiment, a host channel adapter is implemented in hardware. In this implementation, the host channel adapter hardware offloads much of central processing unit and I/O adapter communication overhead. This hardware implementation of the host channel adapter also permits multiple concurrent communications over a switched network without the traditional overhead associated with communicating protocols. In one embodiment, the host channel adapters and SAN 100 in FIG. 1 provide the I/O and interprocessor communications (IPC) consumers of the distributed computer system with zero processor-copy data transfers without involving the operating system kernel process, and employs hardware to provide reliable, fault tolerant communications.

As indicated in FIG. 1, router 117 is coupled to wide area network (WAN) and/or local area network (LAN) connections to other hosts or other routers. The I/O chassis 108 in FIG. 1 includes an I/O switch 146 and multiple I/O modules 148-156. In these examples, the I/O modules take the form of adapter cards. Example adapter cards illustrated in FIG. 1 include a SCSI adapter card for I/O module 148; an adapter card to fiber channel hub and fiber channel-arbitrated loop (FC-AL) devices for I/O module 152; an Ethernet adapter card for I/O module 150; a graphics adapter card for I/O module 154; and a video adapter card for I/O module 156. Any known type of adapter card can be implemented. I/O adapters also include a switch in the I/O adapter backplane to couple the adapter cards to the SAN fabric. These modules contain target channel adapters 158-166.

In this example, RAID subsystem node 106 in FIG. 1 includes a processor 168, a memory 170, a target channel adapter (TCA) 172, and multiple redundant and/or striped storage disk unit 174. Target channel adapter 172 can be a fully functional host channel adapter.

SAN 100 handles data communications for I/O and interprocessor communications. SAN 100 supports high-bandwidth and scalability required for I/O and also supports the extremely low latency and low CPU overhead required for interprocessor communications. User clients can bypass the operating system kernel process and directly access network communication hardware, such as host channel adapters, which enable efficient message passing protocols. SAN 100 is suited to current computing models and is a building block for new forms of I/O and computer cluster communication. Further, SAN 100 in FIG. 1 allows I/O adapter nodes to communicate among themselves or communicate with any or all of the processor nodes in distributed computer system. With an I/O adapter attached to the SAN 100, the resulting I/O adapter node has substantially the same communication capability as any host processor node in SAN 100.

In one embodiment, the SAN 100 shown in FIG. 1 supports channel semantics and memory semantics. Channel semantics is sometimes referred to as send/receive or push communication operations. Channel semantics are the type of communications employed in a traditional I/O channel where a source device pushes data and a destination device determines a final destination of the data. In channel semantics, the packet transmitted from a source process specifies a destination processes' communication port, but does not specify where in the destination processes' memory space the packet will be written. Thus, in channel semantics, the destination process pre-allocates where to place the transmitted data.

In memory semantics, a source process directly reads or writes the virtual address space of a remote node destination process. The remote destination process need only communicate the location of a buffer for data, and does not need to be involved in the transfer of any data. Thus, in memory semantics, a source process sends a data packet containing the destination buffer memory address of the destination process. In memory semantics, the destination process previously grants permission for the source process to access its memory.

Channel semantics and memory semantics are typically both necessary for I/O and interprocessor communications. A typical I/O operation employs a combination of channel and memory semantics. In an illustrative example I/O operation of the distributed computer system shown in FIG. 1, a host processor node, such as host processor node 102, initiates an I/O operation by using channel semantics to send a disk write command to a disk I/O adapter, such as RAID subsystem target channel adapter (TCA) 172. The disk I/O adapter examines the command and uses memory semantics to read the data buffer directly from the memory space of the host processor node. After the data buffer is read, the disk I/O adapter employs channel semantics to push an I/O completion message back to the host processor node.

In one exemplary embodiment, the distributed computer system shown in FIG. 1 performs operations that employ virtual addresses and virtual memory protection mechanisms to ensure correct and proper access to all memory. Applications running in such a distributed computed system are not required to use physical addressing for any operations.

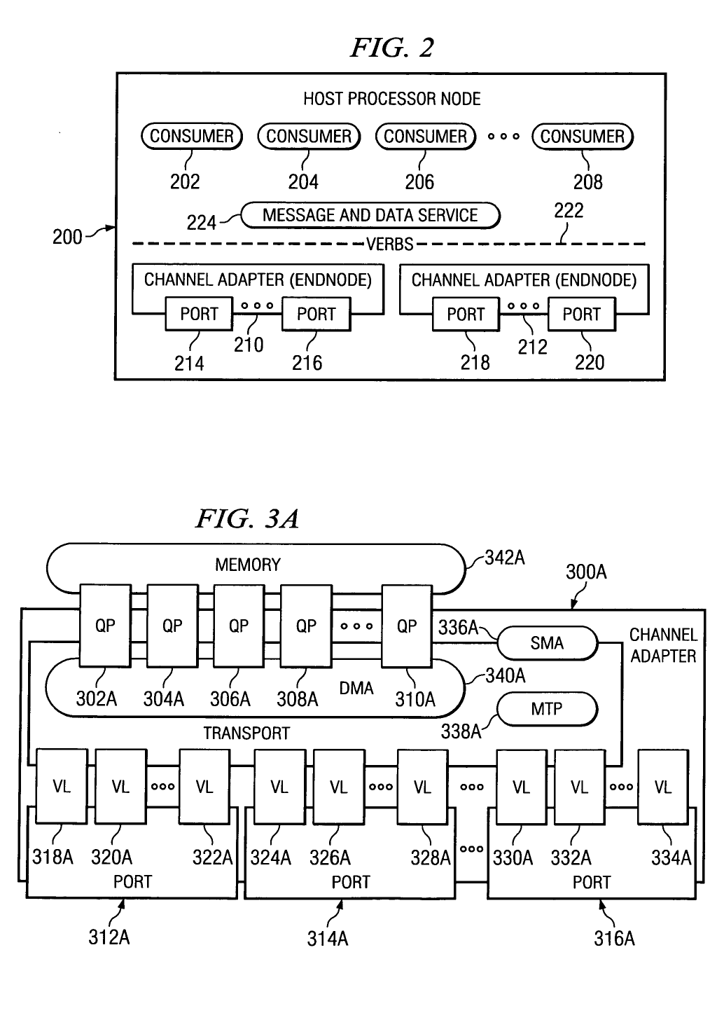

Turning next to FIG. 2, a functional block diagram of a host processor node is depicted in accordance with a preferred embodiment of the present invention. Host processor node 200 is an example of a host processor node, such as host processor node 102 in FIG. 1. In this example, host processor node 200 shown in FIG. 2 includes a set of consumers 202-208, which are processes executing on host processor node 200. Host processor node 200 also includes channel adapter 210 and channel adapter 212. Channel adapter 210 contains ports 214 and 216 while channel adapter 212 contains ports 218 and 220. Each port connects to a link. The ports can connect to one SAN subnet or multiple SAN subnets, such as SAN 100 in FIG. 1. In these examples, the channel adapters take the form of host channel adapters.

Consumers 202-208 transfer messages to the SAN via the verbs interface 222 and message and data service 224. A verbs interface is essentially an abstract description of the functionality of a host channel adapter. An operating system may expose some or all of the verb functionality through its programming interface. Basically, this interface defines the behavior of the host. Additionally, host processor node 200 includes a message and data service 224, which is a higher-level interface than the verb layer and is used to process messages and data received through channel adapter 210 and channel adapter 212. Message and data service 224 provides an interface to consumers 202-208 to process messages and other data.

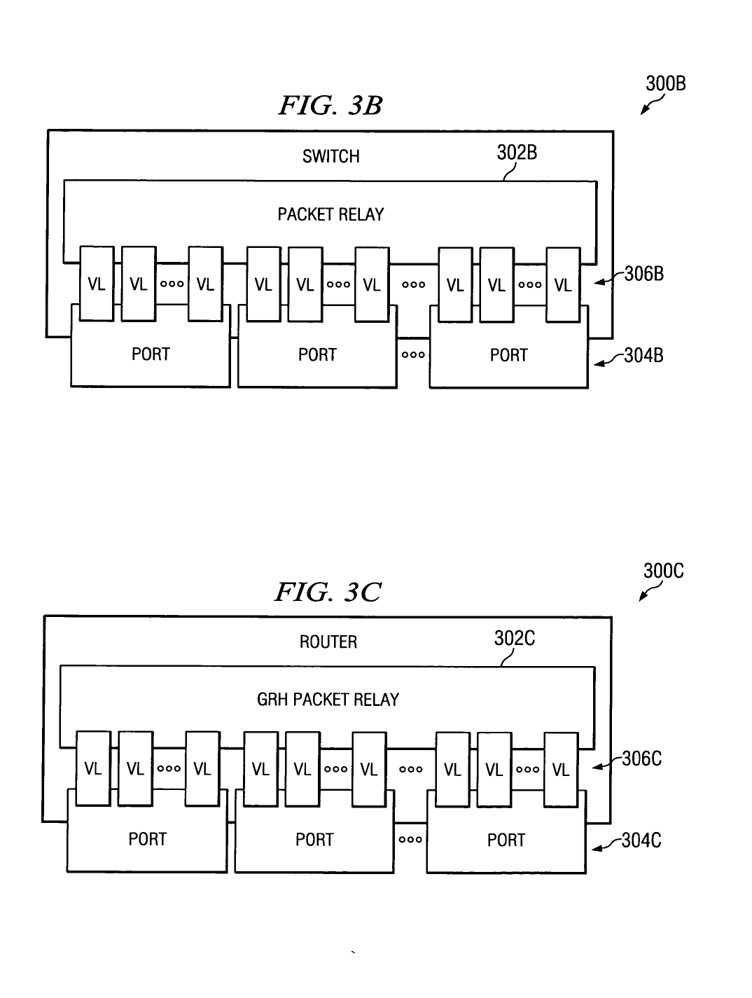

With reference now to FIG. 3A, a diagram of a host channel adapter is depicted in accordance with a preferred embodiment of the present invention. Host channel adapter 300A shown in FIG. 3A includes a set of queue pairs (QPs) 302A-310A, which are used to transfer messages to the host channel adapter ports 312A-316A. Buffering of data to host channel adapter ports 312A-316A is channeled through virtual lanes (VL) 318A-334A where each VL has its own flow control. Subnet manager configures channel adapters with the local addresses for each physical port, i.e., the port's LID. Subnet manager agent (SMA) 336A is the entity that communicates with the subnet manager for the purpose of configuring the channel adapter. Memory translation and protection (MTP) 338A is a mechanism that translates virtual addresses to physical addresses and validates access rights. Direct memory access (DMA) 340A provides for direct memory access operations using memory 342A with respect to queue pairs 302A-310A.

A single channel adapter, such as the host channel adapter 300A shown in FIG. 3A, can support thousands of queue pairs. By contrast, a target channel adapter in an I/O adapter typically supports a much smaller number of queue pairs. Each queue pair consists of a send work queue (SWQ) and a receive work queue. The send work queue is used to send channel and memory semantic messages. The receive work queue receives channel semantic messages. A consumer calls an operating-system specific programming interface, which is herein referred to as verbs, to place work requests (WRs) onto a work queue.

FIG. 3B depicts a switch 300B in accordance with a preferred embodiment of the present invention. Switch 300B includes a packet relay 302B in communication with a number of ports 304B through virtual lanes such as virtual lane 306B. Generally, a switch such as switch 300B can route packets from one port to any other port on the same switch.

Similarly, FIG. 3C depicts a router 300C according to a preferred embodiment of the present invention. Router 300C includes a packet relay 302C in communication with a number of ports 304C through virtual lanes such as virtual lane 306C. Like switch 300B, router 300C will generally be able to route packets from one port to any other port on the same router.

Channel adapters, switches, and routers employ multiple virtual lanes within a single physical link. As illustrated in FIGS. 3A, 3B, and 3C, physical ports connect end nodes, switches, and routers to a subnet. Packets injected into the SAN fabric follow one or more virtual lanes from the packet's source to the packet's destination. The virtual lane that is selected is mapped from a service level associated with the packet. At any one time, only one virtual lane makes progress on a given physical link. Virtual lanes provide a technique for applying link level flow control to one virtual lane without affecting the other virtual lanes. When a packet on one virtual lane blocks due to contention, quality of service (QoS), or other considerations, a packet on a different virtual lane is allowed to make progress. Virtual lanes are employed for numerous reasons, some of which are as follows:

Virtual lanes provide QoS. In one example embodiment, certain virtual lanes are reserved for high priority or isochronous traffic to provide QoS.

Virtual lanes provide deadlock avoidance. Virtual lanes allow topologies that contain loops to send packets across all physical links and still be assured the loops won't cause back pressure dependencies that might result in deadlock.

Virtual lanes alleviate head-of-line blocking. When a switch has no more credits available for packets that utilize a given virtual lane, packets utilizing a different virtual lane that has sufficient credits are allowed to make forward progress.

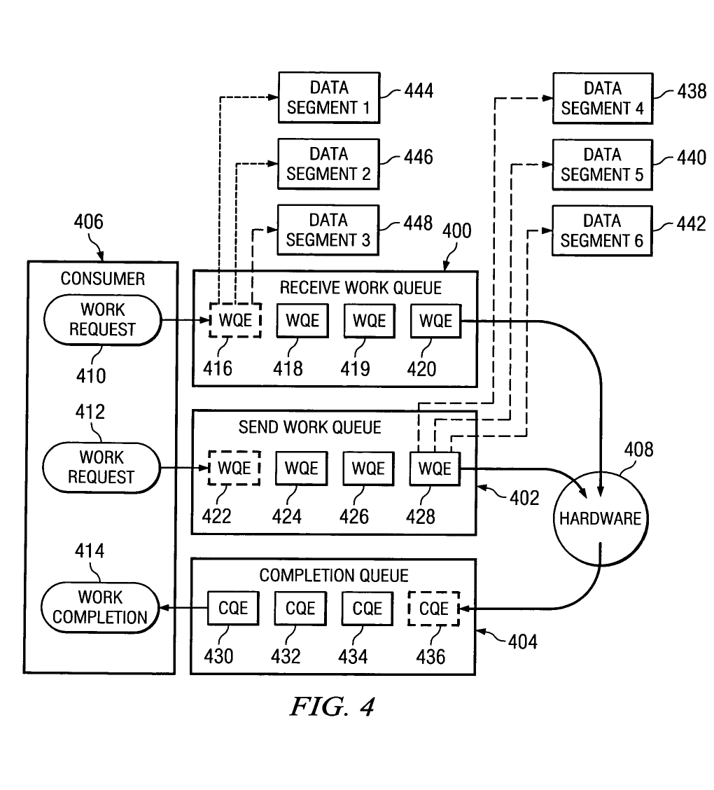

With reference now to FIG. 4, a diagram illustrating processing of work requests is depicted in accordance with a preferred embodiment of the present invention. In FIG. 4, a receive work queue 400, send work queue 402, and completion queue 404 are present for processing requests from and for consumer 406. These requests from consumer 402 are eventually sent to hardware 408. In this example, consumer 406 generates work requests 410 and 412 and receives work completion 414. As shown in FIG. 4, work requests placed onto a work queue are referred to as work queue elements (WQEs).

Send work queue 402 contains work queue elements (WQEs) 422-428, describing data to be transmitted on the SAN fabric. Receive work queue 400 contains work queue elements (WQEs) 416-420, describing where to place incoming channel semantic data from the SAN fabric. A work queue element is processed by hardware 408 in the host channel adapter.

The verbs also provide a mechanism for retrieving completed work from completion queue 404. As shown in FIG. 4, completion queue 404 contains completion queue elements (CQEs) 430-436. Completion queue elements contain information about previously completed work queue elements. Completion queue 404 is used to create a single point of completion notification for multiple queue pairs. A completion queue element is a data structure on a completion queue. This element describes a completed work queue element. The completion queue element contains sufficient information to determine the queue pair and specific work queue element that completed. A completion queue context is a block of information that contains pointers to, length, and other information needed to manage the individual completion queues.

Example work requests supported for the send work queue 402 shown in FIG. 4 are as follows. A send work request is a channel semantic operation to push a set of local data segments to the data segments referenced by a remote node's receive work queue element. For example, work queue element 428 contains references to data segment 4 438, data segment 5 440, and data segment 6 442. Each of the send work request's data segments contains a virtually contiguous memory space. The virtual addresses used to reference the local data segments are in the address context of the process that created the local queue pair.

A remote direct memory access (RDMA) read work request provides a memory semantic operation to read a virtually contiguous memory space on a remote node. A memory space can either be a portion of a memory region or portion of a memory window. A memory region references a previously registered set of virtually contiguous memory addresses defined by a virtual address and length. A memory window references a set of virtually contiguous memory addresses that have been bound to a previously registered region.

The RDMA Read work request reads a virtually contiguous memory space on a remote end node and writes the data to a virtually contiguous local memory space. Similar to the send work request, virtual addresses used by the RDMA Read work queue element to reference the local data segments are in the address context of the process that created the local queue pair. For example, work queue element 416 in receive work queue 400 references data segment 1 444, data segment 2 446, and data segment 3 448. The remote virtual addresses are in the address context of the process owning the remote queue pair targeted by the RDMA Read work queue element.

A RDMA Write work queue element provides a memory semantic operation to write a virtually contiguous memory space on a remote node. The RDMA Write work queue element contains a scatter list of local virtually contiguous memory spaces and the virtual address of the remote memory space into which the local memory spaces are written.

A RDMA FetchOp work queue element provides a memory semantic operation to perform an atomic operation on a remote word. The RDMA FetchOp work queue element is a combined RDMA Read, Modify, and RDMA Write operation. The RDMA FetchOp work queue element can support several read-modify-write operations, such as Compare and Swap if equal. A bind (unbind) remote access key (R_Key) work queue element provides a command to the host channel adapter hardware to modify (destroy) a memory window by associating (disassociating) the memory window to a memory region. The R_Key is part of each RDMA access and is used to validate that the remote process has permitted access to the buffer.

In one embodiment, receive work queue 400 shown in FIG. 4 only supports one type of work queue element, which is referred to as a receive work queue element. The receive work queue element provides a channel semantic operation describing a local memory space into which incoming send messages are written. The receive work queue element includes a scatter list describing several virtually contiguous memory spaces. An incoming send message is written to these memory spaces. The virtual addresses are in the address context of the process that created the local queue pair.

For interprocessor communications, a user-mode software process transfers data through queue pairs directly from where the buffer resides in memory. In one embodiment, the transfer through the queue pairs bypasses the operating system and consumes few host instruction cycles. Queue pairs permit zero processor-copy data transfer with no operating system kernel involvement. The zero processor-copy data transfer provides for efficient support of high-bandwidth and low-latency communication.

When a queue pair is created, the queue pair is set to provide a selected type of transport service. In one embodiment, a distributed computer system implementing the present invention supports four types of transport services: reliable connection, unreliable connection, reliable datagram, and unreliable datagram connection service.

Reliable and Unreliable connected services associate a local queue pair with one and only one remote queue pair. Connected services require a process to create a queue pair for each process that is to communicate with over the SAN fabric. Thus, if each of N host processor nodes contain P processes, and all P processes on each node wish to communicate with all the processes on all the other nodes, each host processor node requires p²×(N−1) queue pairs. Moreover, a process can connect a queue pair to another queue pair on the same host channel adapter.

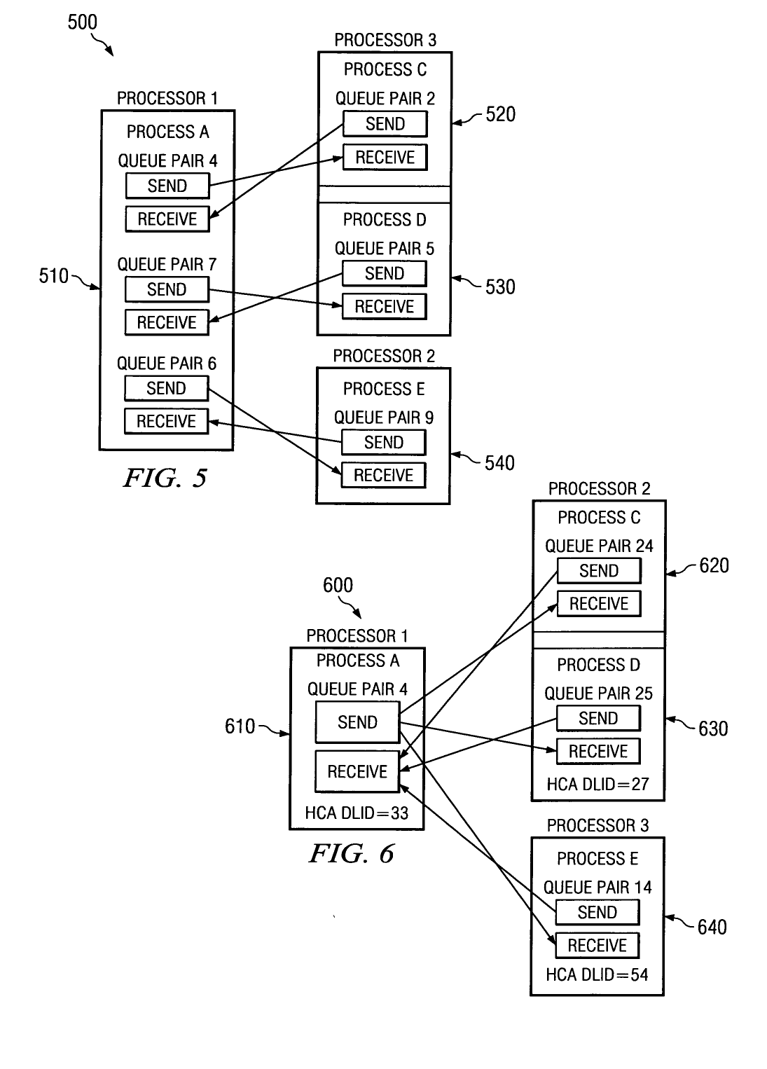

A portion of a distributed computer system employing a reliable connection service to communicate between distributed processes is illustrated generally in FIG. 5. The distributed computer system 500 in FIG. 5 includes a host processor node 1, a host processor node 2, and a host processor node 3. Host processor node 1 includes a process A 510. Host processor node 3 includes a process C 520 and a process D 530. Host processor node 2 includes a process E 540.

Host processor node 1 includes queue pairs 4, 6 and 7, each having a send work queue and receive work queue. Host processor node 2 has a queue pair 9 and host processor node 3 has queue pairs 2 and 5. The reliable connection service of distributed computer system 500 associates a local queue pair with one and only one remote queue pair. Thus, the queue pair 4 is used to communicate with queue pair 2; queue pair 7 is used to communicate with queue pair 5; and queue pair 6 is used to communicate with queue pair 9.

A WQE placed on one queue pair in a reliable connection service causes data to be written into the receive memory space referenced by a Receive WQE of the connected queue pair. RDMA operations operate on the address space of the connected queue pair.

In one embodiment of the present invention, the reliable connection service is made reliable because hardware maintains sequence numbers and acknowledges all packet transfers. A combination of hardware and SAN driver software retries any failed communications. The process client of the queue pair obtains reliable communications even in the presence of bit errors, receive underruns, and network congestion. If alternative paths exist in the SAN fabric, reliable communications can be maintained even in the presence of failures of fabric switches, links, or channel adapter ports.

In addition, acknowledgments may be employed to deliver data reliably across the SAN fabric. The acknowledgment may, or may not, be a process level acknowledgment, i.e. an acknowledgment that validates that a receiving process has consumed the data. Alternatively, the acknowledgment may be one that only indicates that the data has reached its destination.

Reliable datagram service associates a local end-to-end (EE) context with one and only one remote end-to-end context. The reliable datagram service permits a client process of one queue pair to communicate with any other queue pair on any other remote node. At a receive work queue, the reliable datagram service permits incoming messages from any send work queue on any other remote node.

The reliable datagram service greatly improves scalability because the reliable datagram service is connectionless. Therefore, an end node with a fixed number of queue pairs can communicate with far more processes and end nodes with a reliable datagram service than with a reliable connection transport service. For example, if each of N host processor nodes contain P processes, and all P processes on each node wish to communicate with all the processes on all the other nodes, the reliable connection service requires P²×(N−1) queue pairs on each node. By comparison, the connectionless reliable datagram service only requires P queue pairs+(N−1) EE contexts on each node for exactly the same communications.

A portion of a distributed computer system employing a reliable datagram service to communicate between distributed processes is illustrated in FIG. 6. The distributed computer system 600 in FIG. 6 includes a host processor node 1, a host processor node 2, and a host processor node 3. Host processor node 1 includes a process A 610 having a queue pair 4. Host processor node 2 has a process C 620 having a queue pair 24 and a process D 630 having a queue pair 25. Host processor node 3 has a process E 640 having a queue pair 14.

In the reliable datagram service implemented in the distributed computer system 600, the queue pairs are coupled in what is referred to as a connectionless transport service. For example, a reliable datagram service couples queue pair 4 to queue pairs 24, 25 and 14. Specifically, a reliable datagram service allows queue pair 4's send work queue to reliably transfer messages to receive work queues in queue pairs 24, 25 and 14. Similarly, the send queues of queue pairs 24, 25, and 14 can reliably transfer messages to the receive work queue in queue pair 4.

In one embodiment of the present invention, the reliable datagram service employs sequence numbers and acknowledgments associated with each message frame to ensure the same degree of reliability as the reliable connection service. End-to-end (EE) contexts maintain end-to-end specific state to keep track of sequence numbers, acknowledgments, and time-out values. The end-to-end state held in the EE contexts is shared by all the connectionless queue pairs communication between a pair of end nodes. Each end node requires at least one EE context for every end node it wishes to communicate with in the reliable datagram service (e.g., a given end node requires at least N EE contexts to be able to have reliable datagram service with N other end nodes).

The unreliable datagram service is connectionless. The unreliable datagram service is employed by management applications to discover and integrate new switches, routers, and end nodes into a given distributed computer system. The unreliable datagram service does not provide the reliability guarantees of the reliable connection service and the reliable datagram service. The unreliable datagram service accordingly operates with less state information maintained at each end node.

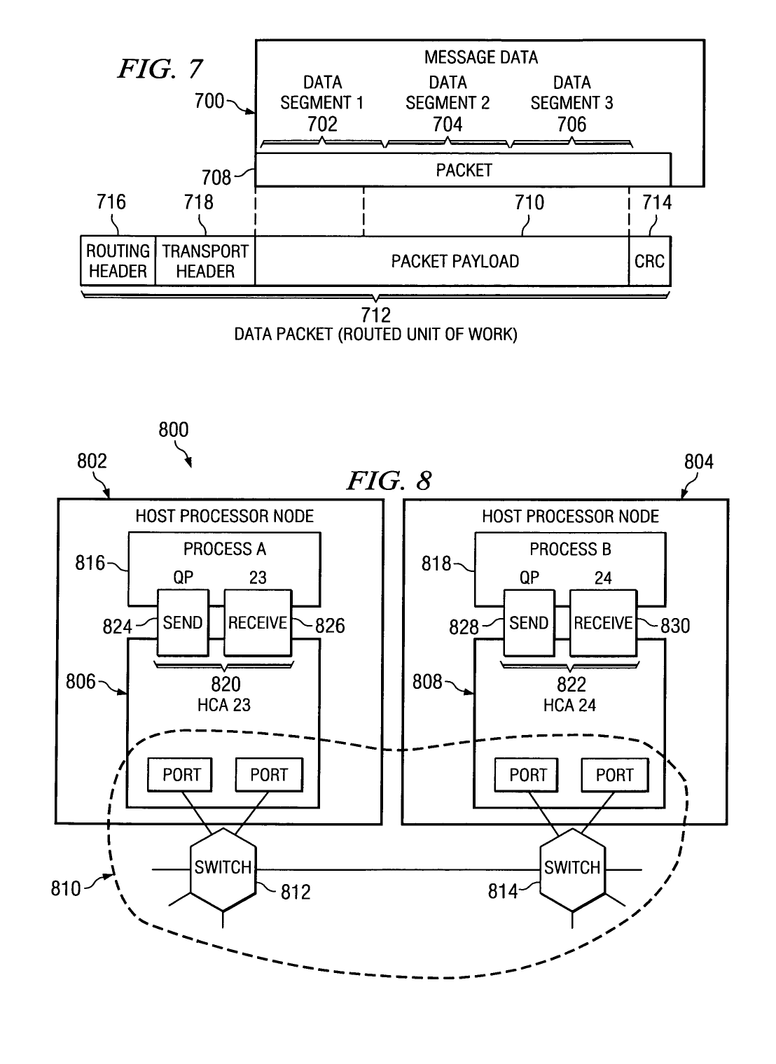

Turning next to FIG. 7, an illustration of a data packet is depicted in accordance with a preferred embodiment of the present invention. A data packet is a unit of information that is routed through the SAN fabric. The data packet is an end-node-to-end-node construct, and is thus created and consumed by end nodes. For packets destined to a channel adapter (either host or target), the data packets are neither generated nor consumed by the switches and routers in the SAN fabric. Instead for data packets that are destined to a channel adapter, switches and routers simply move request packets or acknowledgment packets closer to the ultimate destination, modifying the variant link header fields in the process. Routers, also modify the packet's network header when the packet crosses a subnet boundary. In traversing a subnet, a single packet stays on a single service level.

Message data 700 contains data segment 1 702, data segment 2 704, and data segment 3 706, which are similar to the data segments illustrated in FIG. 4. In this example, these data segments form a packet 708, which is placed into packet payload 710 within data packet 712. Additionally, data packet 712 contains CRC 714, which is used for error checking. Additionally, routing header 716 and transport 718 are present in data packet 712. Routing header 716 is used to identify source and destination ports for data packet 712. Transport header 718 in this example specifies the destination queue pair for data packet 712. Additionally, transport header 718 also provides information such as the operation code, packet sequence number, and partition for data packet 712.

The operating code identifies whether the packet is the first, last, intermediate, or only packet of a message. The operation code also specifies whether the operation is a send, RDMA write, RDMA read, or atomic. The packet sequence number is initialized when communication is established and increments each time a queue pair creates a new packet. Ports of an end node may be configured to be members of one or more possibly overlapping sets called partitions.

In FIG. 8, a portion of a distributed computer system is depicted to illustrate an example request and acknowledgment transaction. The distributed computer system in FIG. 8 includes a host processor node 802 and a host processor node 804. Host processor node 802 includes a host channel adapter 806. Host processor node 804 includes a host channel adapter 808. The distributed computer system in FIG. 8 includes a SAN fabric 810, which includes a switch 812 and a switch 814. The SAN fabric includes a link coupling host channel adapter 806 to switch 812; a link coupling switch 812 to switch 814; and a link coupling host channel adapter 808 to switch 814.

In the example transactions, host processor node 802 includes a client process A. Host processor node 804 includes a client process B. Client process A interacts with host channel adapter hardware 806 through queue pair 23 (824 and 826). Client process B interacts with hardware channel adapter hardware 808 through queue pair 24 (828 and 830). Queue pairs 23 and 24 are data structures that include a send work queue and a receive work queue.

Process A initiates a message request by posting work queue elements to the send queue 824 of queue pair 23. Such a work queue element is illustrated in FIG. 4. The message request of client process A is referenced by a gather list contained in the send work queue element. Each data segment in the gather list points to a virtually contiguous local memory space, which contains a part of the message, such as indicated by data segments 1, 2, and 3, which respectively hold message parts 1, 2, and 3, in FIG. 4.

Hardware in host channel adapter 806 reads the work queue element and segments the message stored in virtual contiguous buffers into data packets, such as the data packet illustrated in FIG. 7. Data packets are routed through the SAN fabric, and for reliable transfer services, are acknowledged by the final destination endnode. If not successively acknowledged, the data packet is retransmitted by the source enanode. Data packets are generated by source endnodes and consumed by destination endnodes.

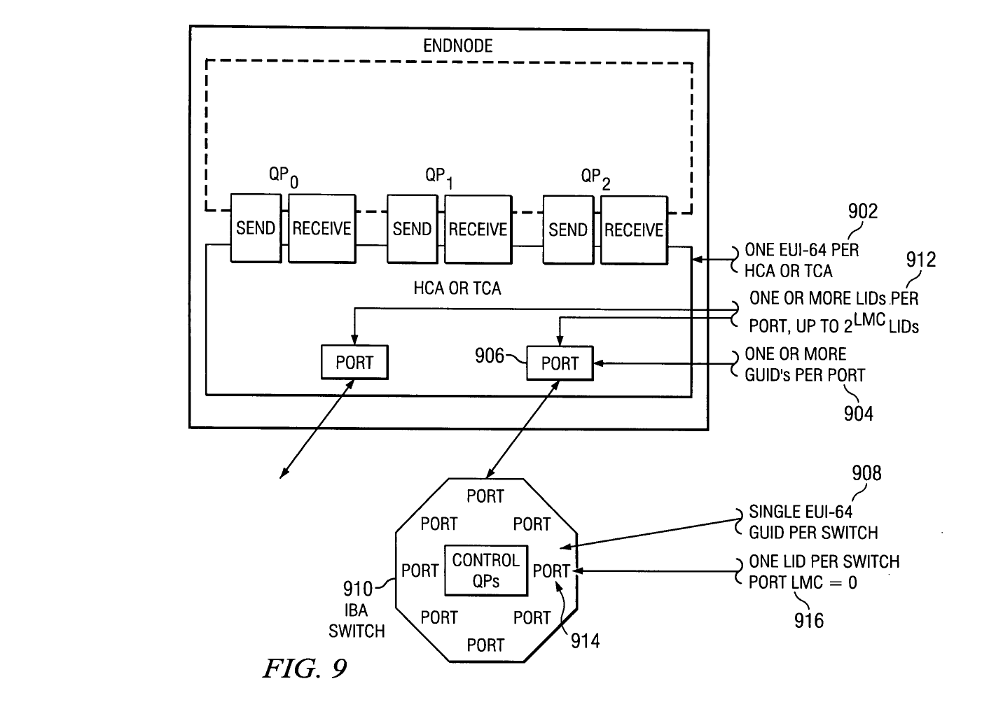

In reference to FIG. 9, a diagram illustrating the network addressing used in a distributed networking system is depicted in accordance with the present invention. A host name provides a logical identification for a host node, such as a host processor node or I/O adapter node. The host name identifies the endpoint for messages such that messages are destined for processes residing on an end node specified by the host name. Thus, there is one host name per node, but a node can have multiple CAs. A single IEEE assigned 64-bit identifier (EUI-64) 902 is assigned to each component. A component can be a switch, router, or CA.

One or more globally unique ID (GUID) identifiers 904 are assigned per CA port 906. Multiple GUIDs (a.k.a. IP addresses) can be used for several reasons, some of which are illustrated by the following examples. In one embodiment, different IP addresses identify different partitions or services on an end node. In a different embodiment, different IP addresses are used to specify different Quality of Service (QoS) attributes. In yet another embodiment, different IP addresses identify different paths through intra-subnet routes.

One GUID 908 is assigned to a switch 910.

A local ID (LID) refers to a short address ID used to identify a CA port within a single subnet. In one example embodiment, a subnet has up to 2¹⁶ end nodes, switches, and routers, and the LID is accordingly 16 bits. A source LID (SLID) and a destination LID (DLID) are the source and destination LIDs used in a local network header. A single CA port 906 has up to 2^{LMC} LIDs 912 assigned to it. The LMC represents the LID Mask Control field in the CA. A mask is a pattern of bits used to accept or reject bit patterns in another set of data.

Multiple LIDs can be used for several reasons some of which are provided by the following examples. In one embodiment, different LIDs identify different partitions or services in an end node. In another embodiment, different LIDs are used to specify different QoS attributes. In yet a further embodiment, different LIDs specify different paths through the subnet. A single switch port 914 has one LID 916 associated with it.

A one-to-one correspondence does not necessarily exist between LIDs and GUIDs, because a CA can have more or less LIDs than GUIDs for each port. For CAs with redundant ports and redundant conductivity to multiple SAN fabrics, the CAs can, but are not required to, use the same LID and GUID on each of its ports.

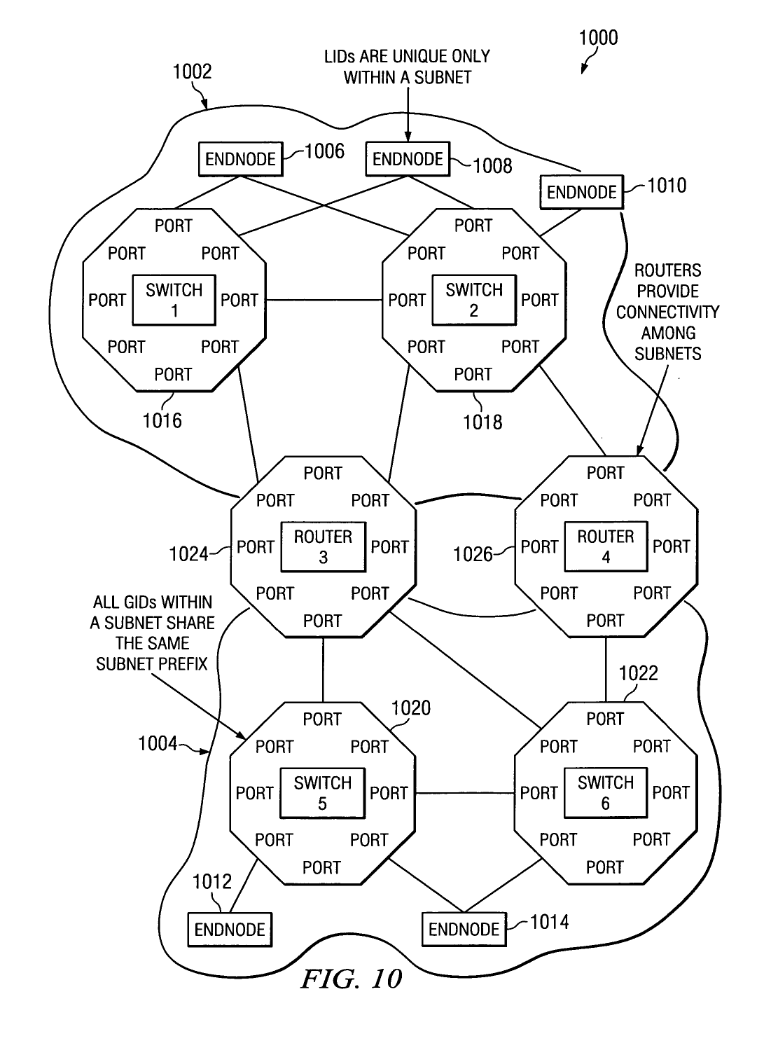

A portion of a distributed computer system in accordance with a preferred embodiment of the present invention is illustrated in FIG. 10. Distributed computer system 1000 includes a subnet 1002 and a subnet 1004. Subnet 1002 includes host processor nodes 1006, 1008, and 1010. Subnet 1004 includes host processor nodes 1012 and 1014. Subnet 1002 includes switches 1016 and 1018. Subnet 1004 includes switches 1020 and 1022.

Routers connect subnets. For example, subnet 1002 is connected to subnet 1004 with routers 1024 and 1026. In one example embodiment, a subnet has up to 2¹⁶ end nodes, switches, and routers.

A subnet is defined as a group of end nodes and cascaded switches that is managed as a single unit. Typically, a subnet occupies a single geographic or functional area. For example, a single computer system in one room could be defined as a subnet. In one embodiment, the switches in a subnet can perform very fast wormhole or cut-through routing for messages.

A switch within a subnet examines the DLID that is unique within the subnet to permit the switch to quickly and efficiently route incoming message packets. In one embodiment, the switch is a relatively simple circuit, and is typically implemented as a single integrated circuit. A subnet can have hundreds to thousands of end nodes formed by cascaded switches.

As illustrated in FIG. 10, for expansion to much larger systems, subnets are connected with routers, such as routers 1024 and 1026. The router interprets the IP destination ID (e.g., IPv6 destination ID) and routes the IP-like packet.

An example embodiment of a switch is illustrated generally in FIG. 3B. Each I/O path on a switch or router has a port. Generally, a switch can route packets from one port to any other port on the same switch.

Within a subnet, such as subnet 1002 or subnet 1004, a path from a source port to a destination port is determined by the LID of the destination host channel adapter port. Between subnets, a path is determined by the IP address (e.g., IPv6 address) of the destination host channel adapter port and by the LID address of the router port which will be used to reach the destination's subnet.

In one embodiment, the paths used by the request packet and the request packet's corresponding positive acknowledgment (ACK) or negative acknowledgment (NAK) frame are not required to be symmetric. In one embodiment employing certain routing, switches select an output port based on the DLID. In one embodiment, a switch uses one set of routing decision criteria for all its input ports. In one example embodiment, the routing decision criteria are contained in one routing table. In an alternative embodiment, a switch employs a separate set of criteria for each input port.

A data transaction in the distributed computer system of the present invention is typically composed of several hardware and software steps. A client process data transport service can be a user-mode or a kernel-mode process. The client process accesses host channel adapter hardware through one or more queue pairs, such as the queue pairs illustrated in FIGS. 3A, 5, and 6. The client process calls an operating-system specific programming interface, which is herein referred to as “verbs.” The software code implementing verbs posts a work queue element to the given queue pair work queue.

There are many possible methods of posting a work queue element and there are many possible work queue element formats, which allow for various cost/performance design points, but which do not affect interoperability. A user process, however, must communicate to verbs in a well-defined manner, and the format and protocols of data transmitted across the SAN fabric must be sufficiently specified to allow devices to interoperate in a heterogeneous vendor environment.

In one embodiment, channel adapter hardware detects work queue element postings and accesses the work queue element. In this embodiment, the channel adapter hardware translates and validates the work queue element's virtual addresses and accesses the data.

An outgoing message is split into one or more data packets. In one embodiment, the channel adapter hardware adds a transport header and a network header to each packet. The transport header includes sequence numbers and other transport information. The network header includes routing information, such as the destination IP address and other network routing information. The link header contains the Destination Local Identifier (DLID) or other local routing information. The appropriate link header is always added to the packet. The appropriate global network header is added to a given packet it the destination end node resides on a remote subnet.

If a reliable transport service is employed, when a request data packet reaches its destination end node, acknowledgment data packets are used by the destination end node to let the request data packet sender know the request data packet was validated and accepted at the destination. Acknowledgment data packets acknowledge one or more valid and accepted request data packets. The requester can have multiple outstanding request data packets before it receives any acknowledgments. In one embodiment, the number of multiple outstanding messages, i.e. Request data packets, is determined when a queue pair is created.

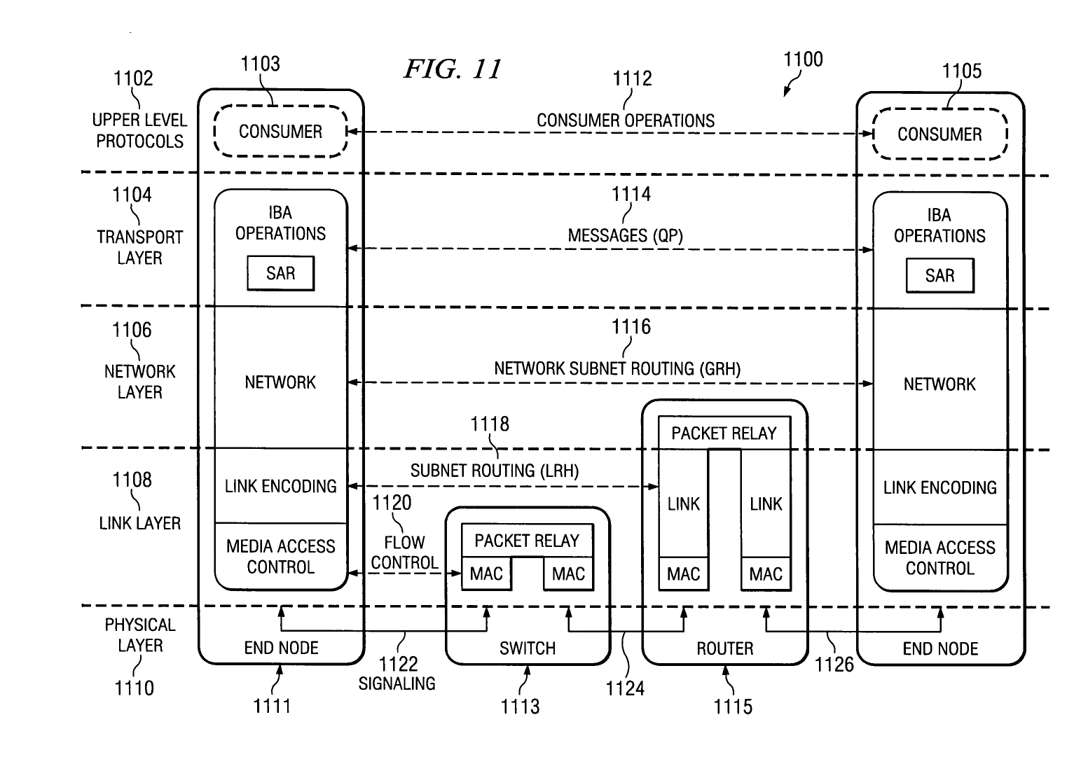

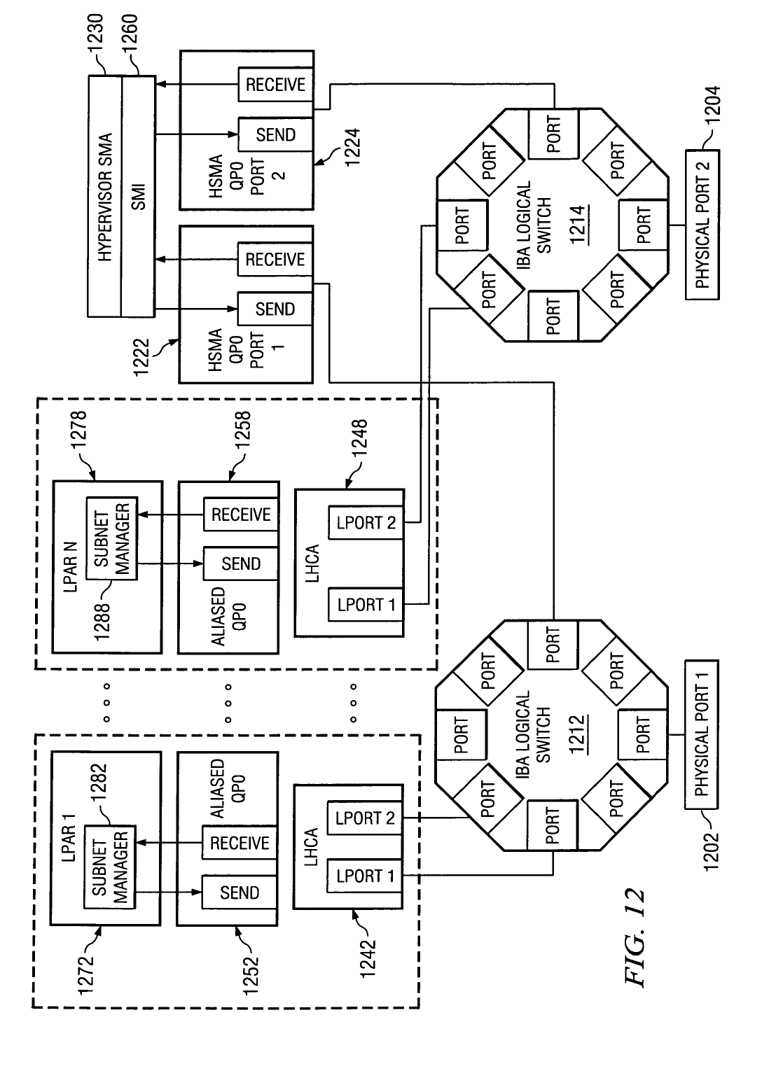

One embodiment of a layered architecture 1100 for implementing the present invention is generally illustrated in diagram form in FIG. 11. The layered architecture diagram of FIG. 11 shows the various layers of data communication paths, and organization of data and control information passed between layers.

Host channel adapter end node protocol layers (employed by end node 1111, for instance) include an upper level protocol 1102 defined by consumer 1103, a transport layer 1104; a network layer 1106, a link layer 1108, and a physical layer 1110. Switch layers (employed by switch 1113, for instance) include link layer 1108 and physical layer 1110. Router layers (employed by router 1115, for instance) include network layer 1106, link layer 1108, and physical layer 1110.

Layered architecture 1100 generally follows an outline of a classical communication stack. With respect to the protocol layers of end node 1111, for example, upper layer protocol 1102 employs verbs to create messages at transport layer 1104. Network layer 1106 routes packets between network subnets (1116). Link layer 1108 routes packets within a network subnet (1118). Physical layer 1110 sends bits or groups of bits to the physical layers of other devices. Each of the layers is unaware of how the upper or lower layers perform their functionality.

Consumers 1103 and 1105 represent applications or processes that employ the other layers for communicating between end nodes. Transport layer 1104 provides end-to-end message movement. In one embodiment, the transport layer provides four types of transport services as described above which are reliable connection service; reliable datagram service; unreliable datagram service; and raw datagram service. Network layer 1106 performs packet routing through a subnet or multiple subnets to destination end nodes. Link layer 1108 performs flow-controlled, error checked, and prioritized packet delivery across links.

Physical layer 1110 performs technology-dependent bit transmission. Bits or groups of bits are passed between physical layers via links 1122, 1124, and 1126. Links can be implemented with printed circuit copper traces, copper cable, optical cable, or with other suitable links.

FIG. 12 depicts a Host Channel Adapter in a Logical Partitioning environment in accordance with a preferred embodiment of the present invention. The HCA includes physical port1 1202 and physical port2 1204. A person of ordinary skill in the art will recognize that the HCA may include more or fewer ports depending on the implementation. The HCA also includes logical switches 1212, 1214. The physical HCA is associated with a plurality of Logical Partitions, LPAR 1 1272 to LPAR N 1278. The LPARs are associated with Logical Host Channel Adapters, LHCA 1 1242 to LHCA N 1248.

Multiple Logical Ports on a Single Physical Port:

The present invention operates within the SAN environment described above with regard to FIGS. 1-12. The present invention satisfies the InfiniBand requirement of a well-known QP0 communication channel being provided for each logical port on a logical HCA and also for each logical switch. Rather than including separate physical resources for each of these low-utilization communications channels, a single physical QP0 and its associated firmware are provided for each physical port. The present invention provides mechanisms for routing and processing this QP0 traffic on behalf of multiple logical ports when there is only a single QP0 associated with the physical port. An external Subnet Manager cannot distinguish the logical switches and logical HCAs with logical ports from real physical entities.

QP0 Requirements:

All logical ports/switches need to support a Subnet Management Agent (SMA) to respond to SM requests. In addition, Subnet Managers 1282-1288 may be needed to run in LPARs 1272-1278. Also, each SM will require a QP0 to communicate with other nodes on the subnet and also logical nodes on the physical HCA. The QP that is used by a Subnet Manager running in a LPAR is referred to as an aliased QP0 1252-1258 and is accessed using the standard IB verbs interface.

In order to support both the manager and agent in the same HCA, all received QP0 packets must first be demultiplexed to determine the intended target. These packets are received on a single QP for each physical port and are processed by hypervisor code referred to as the Hypervisor Subnet Management Agent (HSMA) 1230. This QP is hereafter referred to as HSMA QP0. These QPs are shown as HSMA QP0 Port1 1222 and HSMA QP0 Port2 1224. Subnet Management Interface (SMI) 1260 is used to determine whether a packet is intended for a Subnet Manager or a Subnet Management Agent.

Dataflow of QP0 Traffic within the HCA:

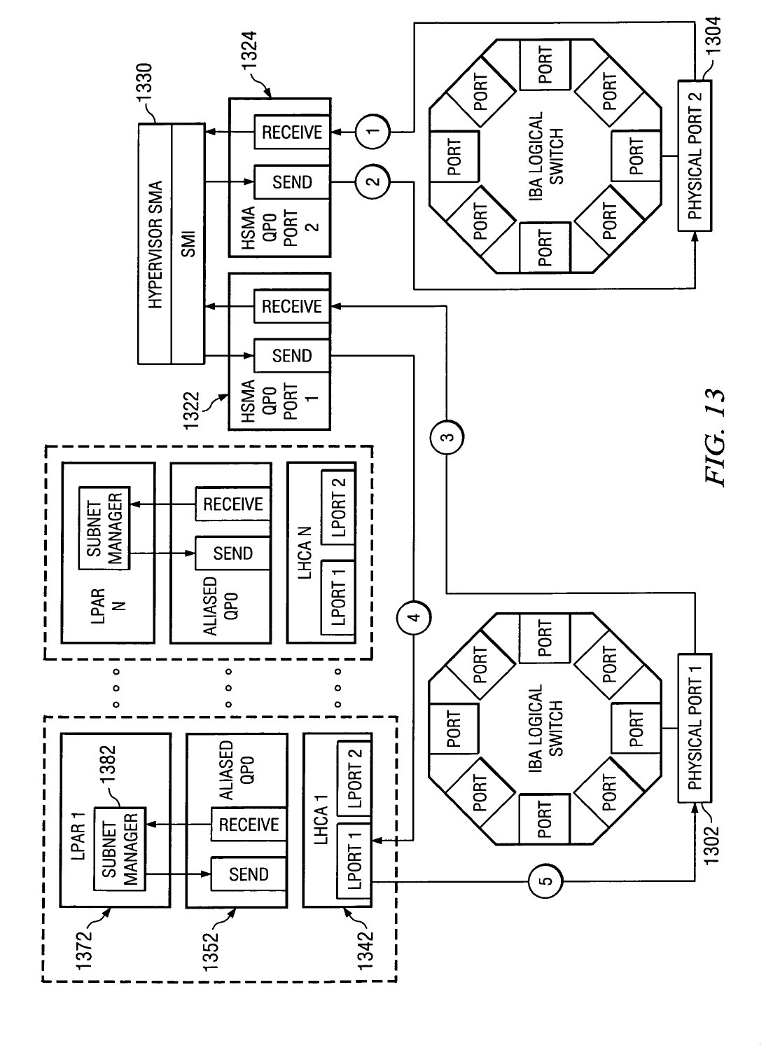

FIG. 13 illustrates an example of subnet management dataflow for traffic in a Logical Partitioning environment in accordance with a preferred embodiment of the present invention. As with all other QPs in this environment, a mechanism is provided to determine whether a received packet should be accepted based on its DLID. Similarly, when transmitting, a mechanism is provided to determine whether the packet should be transmitted externally or looped back to an internal QP.

All QP0 traffic received from an external port (action 1 and 3), such as physical port2 1304, is initially routed through the HCA hardware to the HSMA QP0 1324 for that physical port, which is monitored by Hypervisor SMA 1330 on behalf of all LPARs and the logical switch. The HSMA also responds on behalf of the logical ports (action 2).

A Subnet Management Packet (SMP) is decoded by this common agent in order to determine the final destination of the SMP. If the SMP is to be routed to Subnet Manager 1382 residing in LPAR 1372, the packet received and decoded on the receive queue for HSMA QP0 Port2 1324 is enqueued on the send queue for HSMA QP0 Port 2 1324 for transmission to aliased QP0 1352 through LHCA 1 1342. The HCA hardware loops the packet back to the aliased QP0 in the appropriate LPAR (action 4). QP0 traffic originating from Subnet Manager 1382 may be transmitted directly using the aliased QP0 (action 5).

Directed route traffic, which is identified by packets that use the permissive LID (x′FFFF′), is processed on behalf of the LHCAs or logical switches by the HSMA. The HCA hardware is unable to determine from the LID in this case where the packet is to be routed. Thus, a bit is provided in the WQE to allow the HSMA to direct the outbound packet either to the external port or to an aliased QP0. If directed to an aliased QP0, the HSMA also provides, in the WQE, the real QP number of the aliased QP0 to inform the HCA of the queue on which to place the packet.

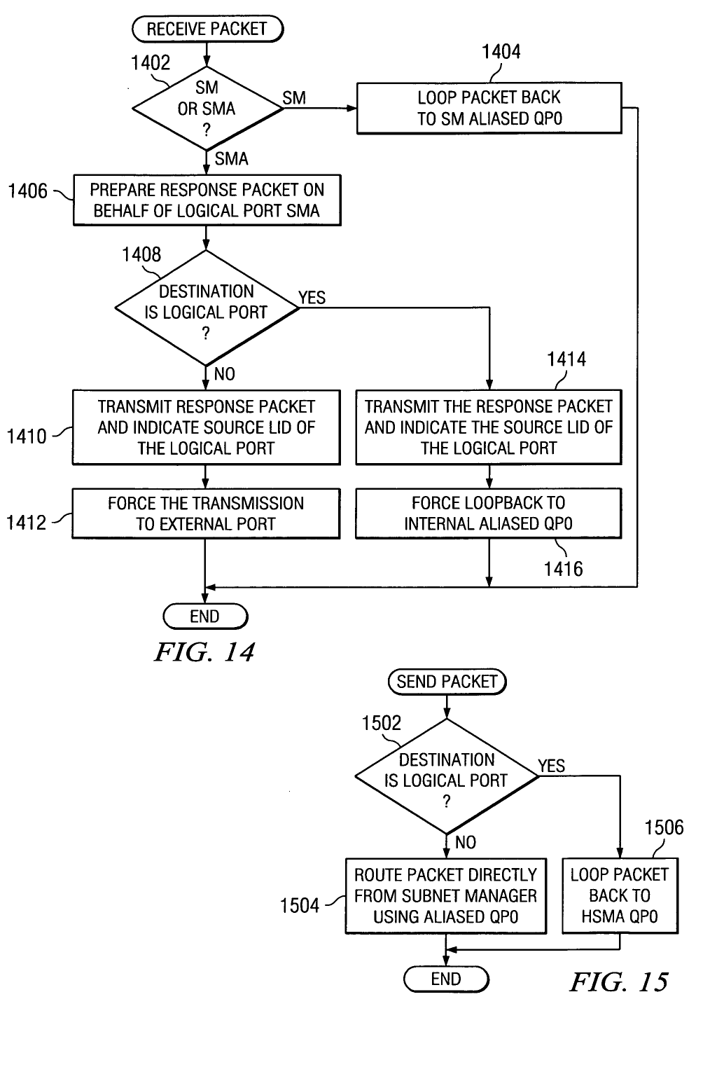

With reference to FIG. 14, a flowchart is shown illustrating the processing of a received packet in a Host Channel Adapter in accordance with a preferred embodiment of the present invention. The process begins by receiving a packet at the HSMA QP0 and a determination is made as to whether the packet is intended for a Subnet Manager or a Subnet Management Agent (step 1402). If the packet is intended for a Subnet Manager, the process loops the packet back to the SM aliased QP0 (step 1404) and ends.

If the packet is intended for a Subnet Management Agent in step 1402, the process prepares a Response Packet on behalf of the logical port SMA (step 1406) and a determination is made as to whether the destination of the response packet is a logical port (step 1408). If the destination of the response packet is an external port, rather than a logical port within the HCA, then the process transmits the response packet and indicates a source LID of the logical port (step 1410). The process then forces the transmission of the response packet to an external physical port (step 1412) and the process ends.

If the response packet is intended for an internal logical port step 1408, then the process transmits the response packet and indicates the source LID of the logical port (step 1414). Thereafter, the process forces loopback to the internal aliased QP0 (step 1416) and the process ends.

With reference now to FIG. 15, a flowchart illustrating the process of sending a packet in a Host Channel Adapter is shown in accordance with a preferred embodiment of the present invention. The process begins when a SM of a LPAR sends a packet. A determination is made as to whether the destination of the packet is a logical port within the HCA (step 1502). If the destination is an external port, the process routes the packet directly from the Subnet Manager using the aliased QP0 (step 1504) and the process ends. If, however, the destination of the packet is a logical port within the HCA in step 1502, the process loops the packet back to the HSMA QP0 (step 1506) and the process ends.

HSMA QP0:

There is one HSMA QP0 per physical port. The association of physical port to HSMA QP0 may be hard-wired or configurable. A simple convention would be to associate QP0 with port 1, QP1 to port 2 and so on up to the number of physical ports supported.

HSMA QP0s may be implemented as special purpose QPs. However, because they share many characteristics with conventional unreliable datagram (UD) QPs, it may be more efficient to implement them as UD QPs with some extra capabilities. In this case, an HSMA QP0 may be identified by a control bit that is associated with an UD QP. This bit could be stored in the UD QP's context, which contains all the state and configuration information pertaining to that QP.

The special capabilities required for an HSMA QP0 are as follows:
1. Ability to receive SMPs destined for any logical port and indicate the intended target to the HSMA. The destination LID of the intended target is provided in the Completion Queue Entry (CQE) associated with the received SMP.
2. Ability to transmit SMPs and provide the source LID of any logical port or any external port in the packet headers. The source LID is provided to the HCA in the Work Queue Element (WQE) placed on the HSMA QP0 send queue.
3. Ability to force the transmission of SMPs to an external physical port or to force loopback to an internal aliased QP0 that is specified in the WQE. The indication for this is provided in a “Force-Out” bit that is provided in the WQE that is placed on the HSMA QP0 send queue.
4. Ability to loop back a SMP to an aliased QP0 by providing the real QP number of the aliased QP in the WQE that is placed on the HSMA QP0 send queue.
5. Ability to transmit SMPs and indicate the source QP as QP0, independent of the QP from which the SMP is being transmitted. This may be either hard-coded for every packet sent from HSMA QP0 or it may be provided by the HSMA in the WQE that is placed on the HSMA QP0 send queue.
6. In addition to the preceding, the HSMA QP0 must conform to all IB-defined characteristics of a QP0 (such as accept a SMP with any Q_Key, always use VL15, be able to receive/transmit packets using the permissive LID, etc.).
   Aliased QP0:

Each instance of a Subnet Manager that wishes to use the physical HCA needs access to the HCA using an aliased QP0. In order to make most efficient use of HCA resources, while allowing maximum scalability, it is advantageous to have the capability to configure regular UD QPs as aliased QP0s. The aliased QP0 is identified by a control bit that is stored in the UD QP's context.

The special capabilities required for an aliased QP0 are as follows:
1. Ability to receive SMPs destined for QP0, independent of the real QP number of the aliased QP0.
2. Ability to receive SMPs looped back from the HSMA QP0.
3. Ability to transmit SMPs with a destination LID of x′FFFF′ that are looped back to the HSMA QP0.
4. Ability to transmit SMPs externally and indicate the source QP as QP0, independent of the QP from which the SMP is transmitted.
5. In addition to the preceding, the aliased QP0 must conform to all IB-defined characteristics of a QP0 (such as accept a SMP with any Q_Key, always use VL15, accept SMPs targeted to the permissive LID, etc.).
   CQs Associated with HSMA QP0s and Aliased QP0S:

HSMA QP0 and aliased QP0s are assigned to CQs in the same way as any other QP. Any CQ may be assigned to any special QP.

The CQE that is placed on a CQ associated with the HSMA QP0 has the full Destination LID provided by the HCA. This DLID in combination with the HSMA QP0 on which the packet arrived (which indicates the port) is used by the HSMA to determine the originally-intended target logical port of the packet.

Thus, the present invention solves the disadvantages of the prior art by providing a well-known QP0 communication channel for each logical port on a logical HCA and also for each switch. Rather than including separate physical resources for each of these low-utilization communications channels, a single physical QP0 and its associated firmware are provided for each physical port. The present invention includes mechanisms for routing and processing QP0 traffic on behalf of multiple logical ports when there is only one single QP0 associated with the physical port. An external Subnet Manager cannot distinguish the logical switches and logical HCAs with logical ports from real physical entities. This virtualization of QP0 can be implemented with very minor enhancements to a HCA, while having the capability of scaling to large numbers of LPARs without consuming additional HCA resources. The present invention also has the advantage of providing QP0 virtualization while using standard InfiniBand-compliant Subnet Managers.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method for emulating multiple logical ports on a physical port, the method comprising:
providing a subnet management queue pair for a physical port;
providing a plurality of logical ports, wherein packets intended for the plurality of logical ports are received at the physical port; and
providing an aliased subnet manager queue pair for each of the plurality of logical ports.

2. The method of claim 1, further comprising:
receiving a packet at the physical port; and
responsive to the packet being intended for a given logical port, looping the packet back to the given logical port.

3. The method of claim 1, further comprising:
sending a packet from an aliased subnet manager queue pair; and
responsive to the packet being intended for a given logical port, looping the packet back to the subnet management queue pair for the physical port.

4. The method of claim 3, further comprising:
responsive to the packet being intended for an external port, routing the packet to the physical port.

5. The method of claim 1, further comprising:
providing a logical switch for the physical port.

6. The method of claim 1, wherein each aliased subnet manager queue pair is associated with a logical partition.

7. The method of claim 1, further comprising:
providing a hypervisor subnet management agent, wherein the hypervisor subnet management agent routes traffic for the plurality of logical ports.

8. The method of claim 7, wherein the hypervisor subnet management agent transmits response packets on behalf of the plurality of logical ports.

9. The method of claim 1, wherein each subnet management queue pair is an InfiniBand queue pair zero.

10. An apparatus for emulating multiple logical ports on a physical port, the apparatus comprising:
a subnet management queue pair for a physical port;
a plurality of logical ports, wherein packets intended for the plurality of logical ports are received at the physical port; and
an aliased subnet manager queue pair for each of the plurality of logical ports.

11. The apparatus of claim 10, further comprising:
a hypervisor subnet management agent, wherein the hypervisor subnet management agent routes traffic for the plurality of logical ports.

12. The apparatus of claim 11, wherein the hypervisor subnet management agent receives a packet at the physical port and, responsive to the packet being intended for a given logical port, loops the packet back to the given logical port.

13. The apparatus of claim 11, wherein the hypervisor subnet management agent transmits response packets on behalf of the plurality of logical ports.

14. The apparatus of claim 10, further comprising:
a logical switch associated with the physical port.

15. The apparatus of claim 14, wherein an aliased subnet manager queue pair sends a packet and wherein the logical switch, responsive to the packet being intended for a given logical port, loops the packet back to the subnet management queue pair for the physical port.

16. The apparatus of claim 15, wherein the logical switch, responsive to the packet being intended for an external port, routes the packet to the physical port.

17. The apparatus of claim 10, wherein each aliased subnet manager queue pair is associated with a logical partition.

18. The apparatus of claim 10, wherein each subnet management queue pair is an InfiniBand queue pair zero.

19. A host channel adapter comprising:
one or more physical ports;
a queue pair zero for each physical port, wherein packets received at a physical port are placed in a corresponding queue pair zero;
a plurality of logical host channel adapters, wherein each logical host channel adapter is associated with a logical partition, wherein each logical host channel adapter has at least one logical port, and wherein each logical port has an associated aliased queue pair zero;
a hypervisor subnet management agent, wherein the hypervisor subnet management agent receives packets at a queue pair zero for a physical port, transmits response packets on behalf of the logical ports, and routes the packets to the intended logical ports.

20. The host channel adapter of claim 19, further comprising:
a logical switch associated with a given physical port, wherein the logical switch receives a packet from an aliased queue pair zero and, responsive to the packet being intended for a given logical port, loops the packet back to a queue pair zero for a physical port.
